(19) United States
(12) Patent Application Publication
(10) Pub. No.: US 2015/0217673 A1
(43) Pub. Date: Aug. 6, 2015

(54) ROLL OVER BUNK RESTRAINT SYSTEM AND METHOD

(71) Applicant: VOLVO GROUP NORTH AMERICA, LLC, Greensboro, NC (US)

(72) Inventor: Richard V. Langhoff, Greensboro, NC (US)

(21) Appl. No.: 14/421,939

(22) PCT Filed: Aug. 22, 2012
(86) PCT No.: PCT/US12/51779

§ 371 Date: Feb. 16, 2015

(51) Int. Cl. B60P 3/38; B60R 21/06

(52) U.S. Cl. CPC B60P 3/38; B60R 21/06; B60R 2021/0034

(57) ABSTRACT

The present invention relates to a roll over restraint system for a vehicle. The roll over restraint system includes a mattress, restraint belt section, and one or more activation sensors. The restraint belt section extends laterally across the mattress. The one or more activation sensors detect the occurrence of at least one of a vehicle declaration threshold, a vehicle attitude change threshold, or a vehicle crash and in response thereto generate a signal. The signal results in at least one pre-tensioning devices increasing the tension applied to the restraint belt section and/or inflation of the restraint belt section.

### FIELD OF THE INVENTION

The present invention relates to a roll over restraint system and method for vehicle sleeping bunks.

### BACKGROUND OF THE INVENTION

Moving vehicles, such as truck tractors, RVs, and trains may be provided with sleeping bunks. In order to maintain an occupant in a bunk during the occurrence of an accident, a variety of restraint systems have been developed. Such restraint systems typically include straps, netting, harness, or mesh that when in use prevents an occupant from being ejected from the bunk. While effective for preventing an occupant from being ejected from the bunk and being injured as a result, many restraint systems are not effective at preventing lateral or vertical accelerations, especially as those that might be generated during a rollover crash.

FIG. 1 shows a bunk restraint system as described in U.S. Pat. No. 5,690,355. As shown therein, a bunk or bed 12 of the type found in truck sleeper compartments is illustrated. According to U.S. Pat. No. 5,690,355, the bunk includes support sections 15, 15A at a height typically between 0.3 and 0.6 meters (one and two feet) from the cab floor 14A. A reclining occupant 24 is also shown. A shelf 16 is extended above the occupant 24 by hinged, folding or telescoping brackets 17 which have a forward end 18 attached to the shelf 16 and a rearward end 19 attached to the rear wall 14 of the cab. The rear section of the shelf 16 is attached to the rear cab wall 14 using a piano-hinge type pivoting support 17A. Attachment clips 30 along the front section of the shelf 16 are located for attachment of the privacy restraint curtain eyelets 31. Similarly, the lower section of the privacy restraint curtain 20 has eyelets 31a for attachment to front bunk clips 30a. The privacy restraint curtain 20 is constructed of a suitably strong fabric such as a coarse mesh (as illustrated) or airbag cushion material to restrain the occupant during rapid deceleration during braking or a crash. Other materials that can be used as a privacy curtain are canvas and nylon. Airbag modules 21 are installed within the shelf assembly 16 and suitably located to provide desired coverage of the occupant 24 when deployed.

In the event of a crash, the privacy restraint curtain 20 is designed to prevent an occupant from being ejected from the bunk in the event or rapid deceleration. The airbags modules 21 are designed to protect an occupant during a rollover conditions and may be provided with inflation characteristics that actually hold an occupant in place during a rollover so that secondary occupant impacts do not occur.

While the bunk restraint system show in U.S. Pat. No. 5,690,355 is intended provide some protection during a rollover event, the system could only possibly provide protection in vehicles with a shelf or support of some kind located directly over the bunk. Not all bunk designs are provided with a shelf or support located directly over the bunk. Furthermore, the hinged, folding, or telescoping brackets 17 shown in the arrangement of U.S. Pat. No. 5,690,355 are unlikely to withstand the forces applied to the shelf in the event of a roll over event. In the event of the brackets 17 failing, the airbag modules would fail to actually hold an occupant in place. Accordingly, it is likely that such a system could only be utilized where the support or shelf is substantially reinforced. Furthermore, the necessary inflation characteristics required to hold an occupant in place will of course depend on a large number of factors, including the height of the bed, which according to U.S. Pat. No. 5,690,355 typically varies from 0.3 to 0.6 meters, the type and thickness of the mattress used, the girth of the occupant, and the vertical distance of the shelf 16 or any other support over the bed. Faced with such a large number of variables, a bunk restraint system such as that shown in U.S. Pat. No. 5,690,355 would require significant engineering/customization for each vehicle it is employed in and possibly for each occupant that it is intended to protect, before it could safely ensure that any particular occupant would safely be held in place during a rollover.

U.S. Pat. No. 6,644,724 shows a modular bunk assembly provided with a pair of restraint safety belts that extend transversely, with respect to the longitudinal direction of the bunk. While possibly providing protection in the event of a roll over event, the safety belts would need to be taut such that an occupant was strapped to the bed before an occupant would be guaranteed to be held in place during a roll over event. Due to the uncomfortable nature of such an arrangement and the encumbrances this would place on an occupant, it is unlikely that an occupant would utilize the restraints in such a manner. Furthermore, even if an occupant used the restraints in such a manner, such a use would prevent a restful sleep.

U.S. Pat. No. 7,631,896 shows a tented safety belt webbing restraint system that includes a tented portion that extends some distance directly above the occupant as the occupant is located in bunk. While providing some level of protection, in the event of a roll over event, such an arrangement would not prevent an occupant's head and/or feet from striking the side of the bunk or the occupant from striking the rear wall of the bunk. Furthermore, during a roll over event, the occupant could still be injured if thrown at great force against the tented portion of the safety belt webbing.

The present invention relates to an improved roll over restraint system and method.

### SUMMARY OF THE INVENTION

According to one embodiment of the present invention, a roll over bunk restraint system for a vehicle comprises a mattress, a restraint belt section, first and second restraint belts, at least one pre-tensioning device, and one or more activation sensors. The restraint belt section is provided with a first end and a second end and extends laterally across the mattress. The at least one pre-tensioning device is associated with the second end of the restraint belt section. The one or more activation sensors detect the occurrence of at least one of a vehicle declaration threshold, a vehicle attitude change threshold, or a vehicle crash and in response thereto generate a signal that results in the at least one pre-tensioning device increasing the tension applied to the restraint belt section.

According to another embodiment of the present invention, a method for providing a roll over bunk restraint system in a vehicle comprises the steps of providing a mattress, providing a restraint belt section provided with a first end and a second end, wherein the restraint belt section is configured to extend laterally across the mattress, providing at least one pre-tensioning device that is associated with the second end of the restraint belt section, and providing one or more sensors that are configured to the occurrence of at least one of a vehicle declaration threshold, a vehicle attitude change threshold, or a vehicle crash and in response thereto generate a signal that results in in the at least one pre-tensioning device increasing the tension applied to the restraint belt section.

According to another embodiment of the present invention, a method for providing a roll over bunk restraint system in a vehicle comprises the steps of providing a mattress, providing a restraint belt section that includes a first end and second end, wherein the restraint belt section is configured to extend laterally across the mattress and inflate to increase a restraint force exerted by the restraint belt section on an occupant, whereby the occupant is substantially held in place on the mattress, and providing one or more activation sensors that are configured to detect the occurrence of at least one of a vehicle declaration threshold, a vehicle attitude change threshold, or a vehicle crash and in response thereto generate a signal that results in restraint belt section inflating.

### BRIEF DESCRIPTION OF THE DRAWINGS

FIG. 1 depicts a perspective view of a bunk restraint system shown in U.S. Pat. No. 5,690,355.

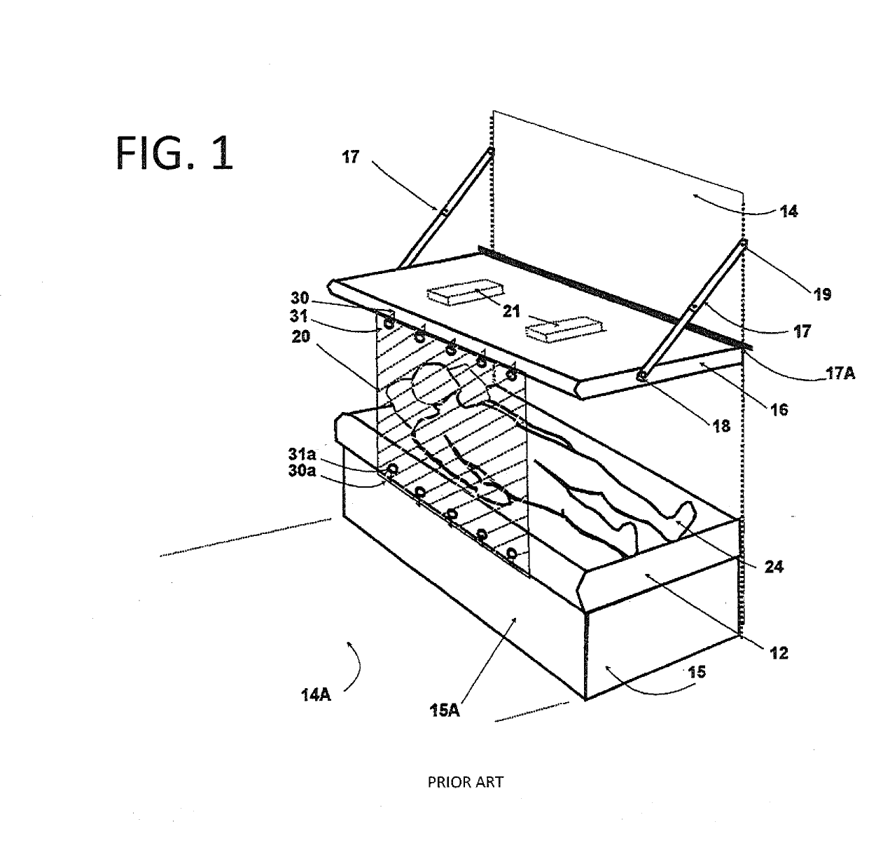

FIG. 2 depicts a perspective view of a roll over bunk restraint system according to one embodiment.

FIG. 3 depicts a top view of a roll over bunk restraint system according to one embodiment.

FIG. 4 depicts a perspective view of a roll over bunk restraint system according to one embodiment.

FIG. 5 depicts a perspective view of a roll over bunk restraint system according to one embodiment.

FIG. 6 depicts a perspective view of a roll over bunk restraint system according to one embodiment.

FIG. 7 depicts a perspective view of a roll over bunk restraint system according to one embodiment.

FIG. 8 depicts a perspective view of a roll over bunk restraint system according to one embodiment.

FIG. 9 depicts a perspective view of a roll over bunk restraint system according to one embodiment.

### DETAILED DESCRIPTION OF THE INVENTION

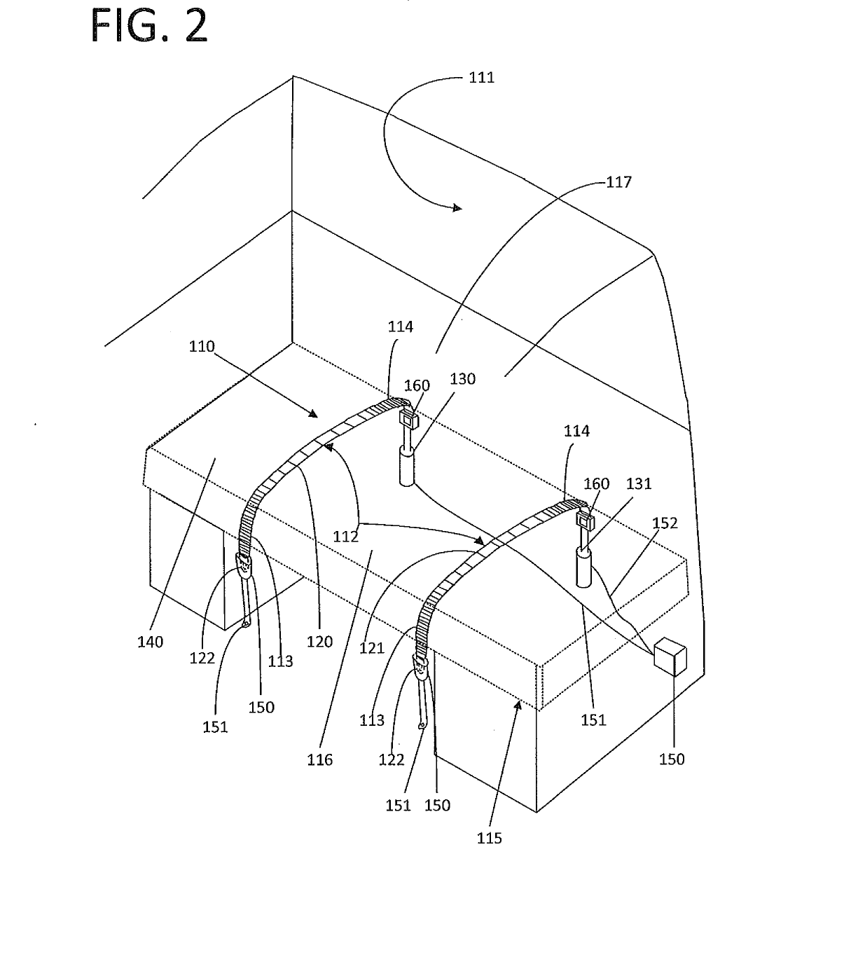

FIG. 2 depicts a roll over restraint system 110 for a bunk 115 in a vehicle cab 111, according to one embodiment of the present invention. As shown, the roll over restraint system 110 is provided with a restraint belt section 112, first and second belt pre-tensioning devices 130 and 131, a mattress 140 and one or more activation sensors 150.

As shown in FIG. 2, the restraint belt section 112 extends laterally across the mattress 140. As shown the restraint belt section 112 may be provided with opposing first end 116 and second end 117. As shown, the first end 113 may be located proximate to an entrance side 116 of the bunk 115 and the second end 114 may be located proximate to a back wall 117 of the bunk 115.

The first end 113 of the restraint belt section 112 is preferably configured to be releasably buckled; however, alternative arrangements are within the scope of the present invention, such as, for example, and not limitation, clasping or fastening. As shown, the first end 113 may be provided with tongues 122 that are releasably received within buckles 150. The buckles are 150 are mounted to a support structure, such as the cab floor, as shown at 151, but may also, within the scope of the present embodiment, be mounted to the bunk 116 or any other suitable support structure. Alternatively, within the scope of the present embodiment, the first end 113 may be provided with buckles (not shown) that releasably receive tongues (not shown) mounted to a support structure.

Within the scope of the present embodiment, the second end 114 may be releasably buckled, as described in relation to the first end 113; however, as shown, the second end 114 is preferably associated with retractors 160, which may be of the locking type or the non-locking type. Those of ordinary skill in the art will appreciate that the retractors 160 exert a slight tension force on the restraint belt section 112 while at the same time permitting the restraint belt section 112 to extend therefrom while in use. Advantageously, the use of retractors 160 allows for free movement of an occupant in the bunk when the restraint system 110 is in use while at the same time ensuring that the restraint belt section 112 is taut against the occupant.

According to one aspect of the present embodiment, the restraint belt section 112 is configured to hold an occupant substantially in place on the bunk 115 during a roll over event of the vehicle. According to another aspect of the present embodiment, the restraint belt section 112 is configured to experience an increase in tension when a roll over event is detected by the one or more activation sensors 150.

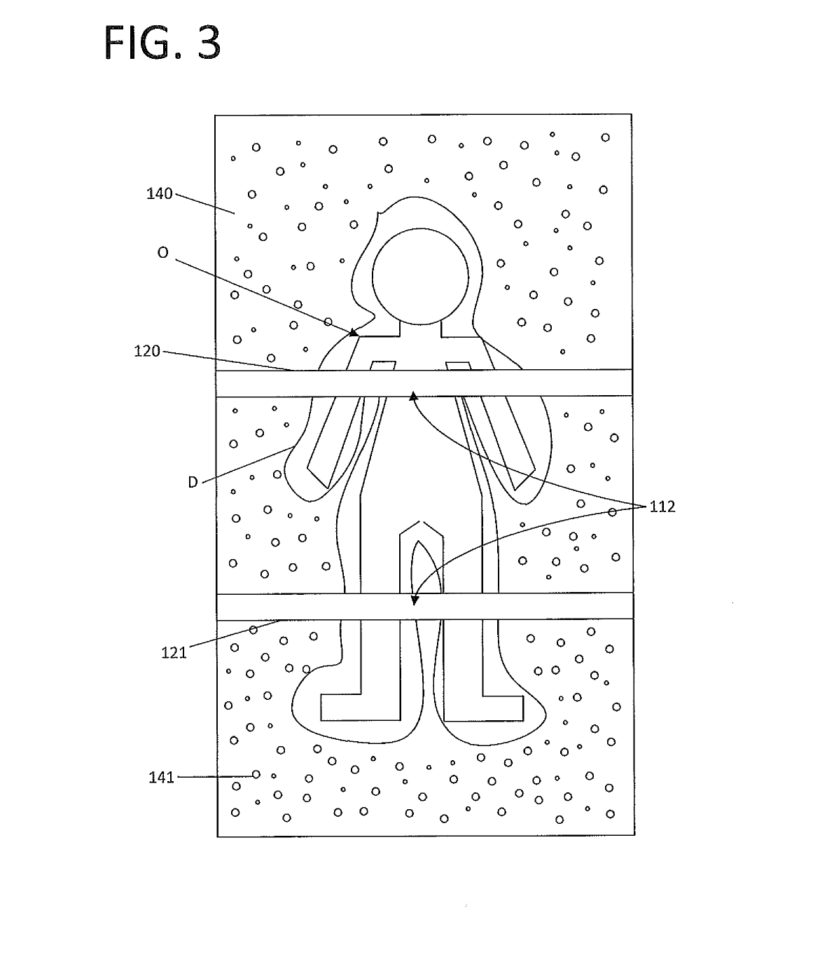

As FIG. 2 shows, the first and second pre-tensioning devices 130, 131 are associated with the second end 120 of the restraint belt section 112, which in the present embodiment includes a first restraint belt 120 and a second restraint belt 121 . . . Advantageously, the pre-tensioning devices 130, 131 increases the tension applied to the first and second restraint belts 120, 121 and tighten the first and second restraint belts 120, 121 against the occupant, in the event of a roll over event. Although any type of pre-tensioning system may be employed, in the preferred embodiment, the pre-tensioning devices 130, 131 are provided with pistons (not shown) that rotate spools (not shown) provided on the retractors 160, 161 to tighten the first and second restraint belts 120, 121 in the event of a roll over event. As shown in FIG. 3, when the pre-tensioning devices 130, 131 are activated, the occupant O is preferably forcibly depressed, as indicated at D, into the mattress 140 by the first and second restraint belts 120, 121 and held in place.

As shown in FIG. 2, the one or more activation sensors 150 are preferably in communication, as shown at 151, 152 with the first and second pre-tensioning devices 130, 131. Advantageously, when a roll over event is detected by the activation sensor 150, the activations generate a signal that results in the first and second pre-tensioning devices 130, 131, increasing the tension applied to the first and second restraint belts 120, 121, as shown in FIG. 3. Within the scope of the present embodiment, any type of suitable activation sensors 150 may be utilized, including but not limited to inclinometers, accelerometers, and/or gyroscopes. Furthermore the one or more sensors may, within the scope of the present embodiment, be located anywhere on the vehicle.

As shown in FIG. 3, the mattress 140 is preferably fabricated primarily from vicso-elastic polyurethane foam 141, also known as memory foam; however, within the scope of the present embodiment other types of mattresses 140 may be used. Advantageously, as shown in FIG. 3, when the pre-tensioning devices 130, 131 are activated, the occupant O is forcibly depressed into memory foam 141, whereby the memory foam 141 partially encapsulates the occupant's body to reduce the chance of an occupant O sliding out from under the restraint belt section 112, during a roll over event.

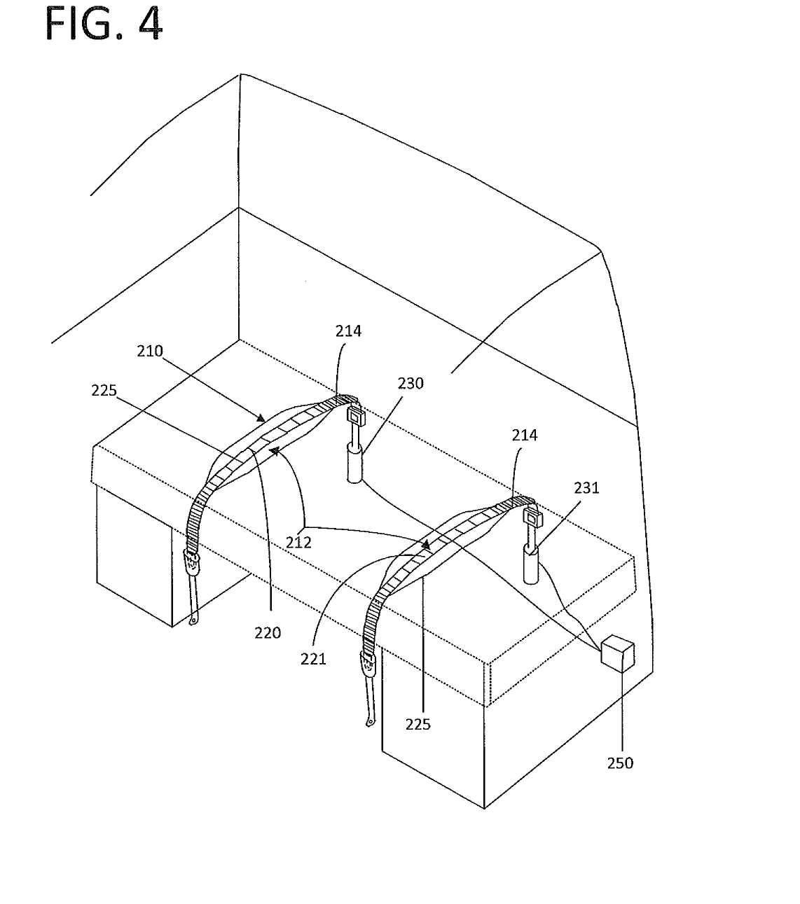

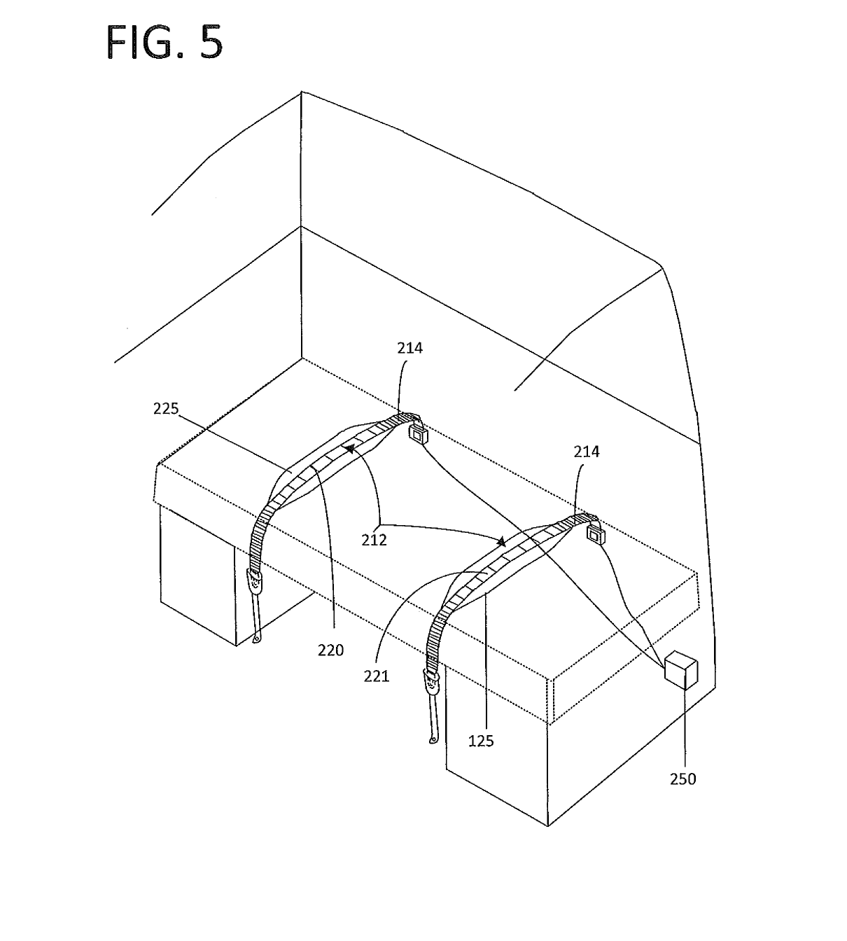

Turning now to FIG. 4, a rollover restraint system 210 according to an alternative embodiment is depicted. The roll over restraint system 210 is similar to roll over restraint system 110, except the first and second restraint belts 220, 221 of the restraint belt section 212 include or define internal bladders 225 that inflate the restraint belt section 112 when one or more activation sensors 250 detect a roll over event. Within the scope of the present invention, first and second pre-tensioning devices 230, 231 may be associated with the second end 114 as described in relation to the embodiment shown in FIG. 2; however, as shown in FIG. 5, it is within the scope of the present embodiment to rely on the bladders 225 to increase the restraint force exerted by the first and second restraint belts 220, 221 on an occupant O, whereby the occupant is substantially held in place on the mattress 140, in the event of a roll over event.

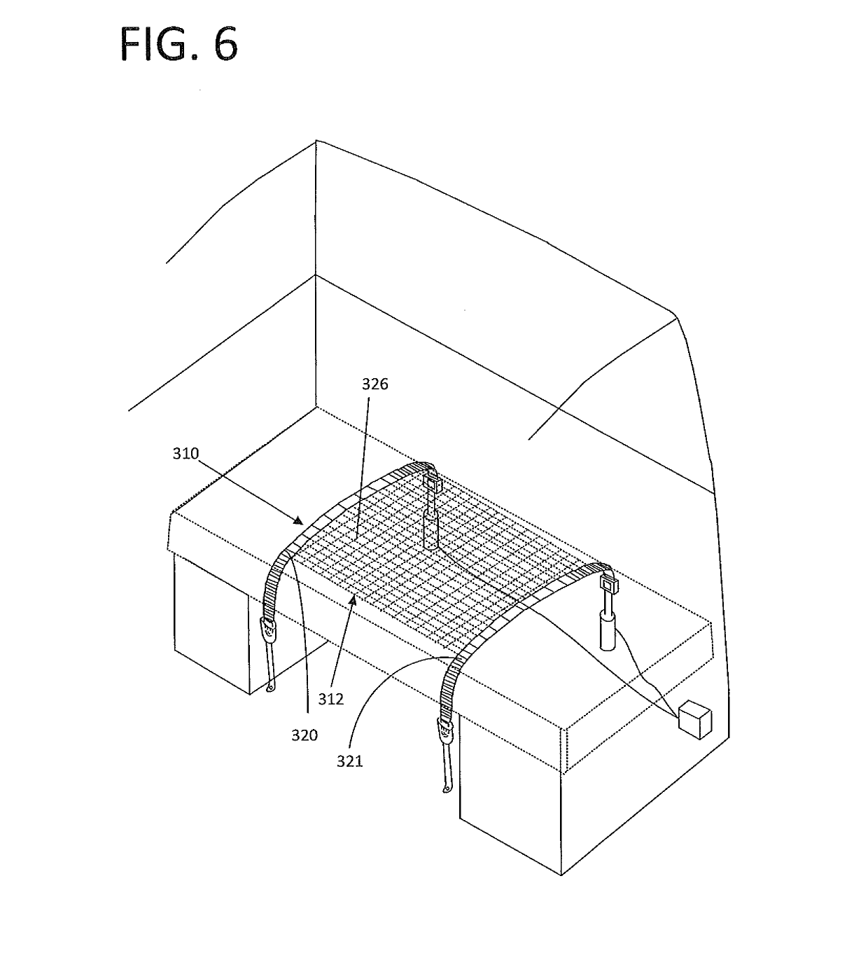

Turning now to FIG. 6, a roll over restraint system 310 according to another alternative embodiment is depicted. The roll over restraint system 310 is similar to roll over restraint system 110, except the restraint belt section 312 includes first and second restraint belts 320, 321 that are interconnected by webbing 326.

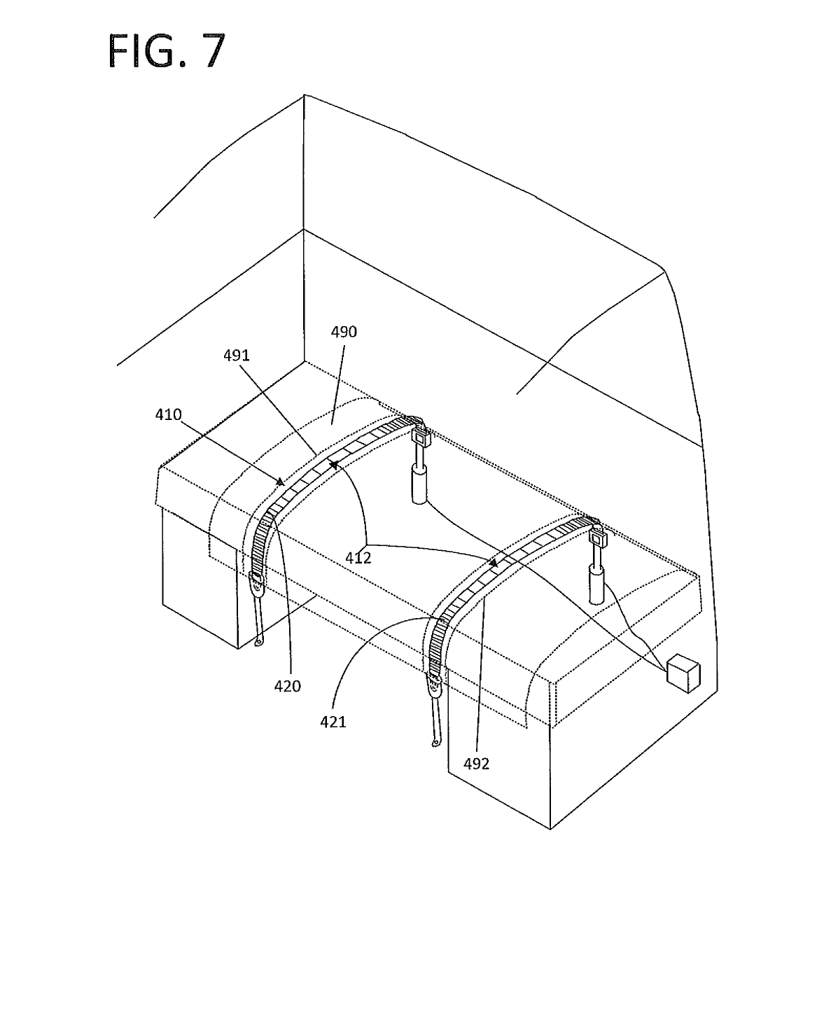

Turning now to FIG. 7, a roll over restraint system 410 according to another alternative embodiment is depicted. The roll over restraint system 410 is similar to roll over restraint system 110, except a blanket 490 is further provided. As shown, the blanket 490 is provided with first and second sleeves 491, 492, that extend laterally across the blanket 490 and that removably receive the restraint belt section 412 . . . Within the scope of the present embodiment, the sleeves 491, 492 may be located on the outer surface or inner surface of the blanket 490 or internally within the blanket 490. Advantageously, the sleeves 491, 492 may prevent the blanket 490 from getting bunched up by the restraint belt section 412.

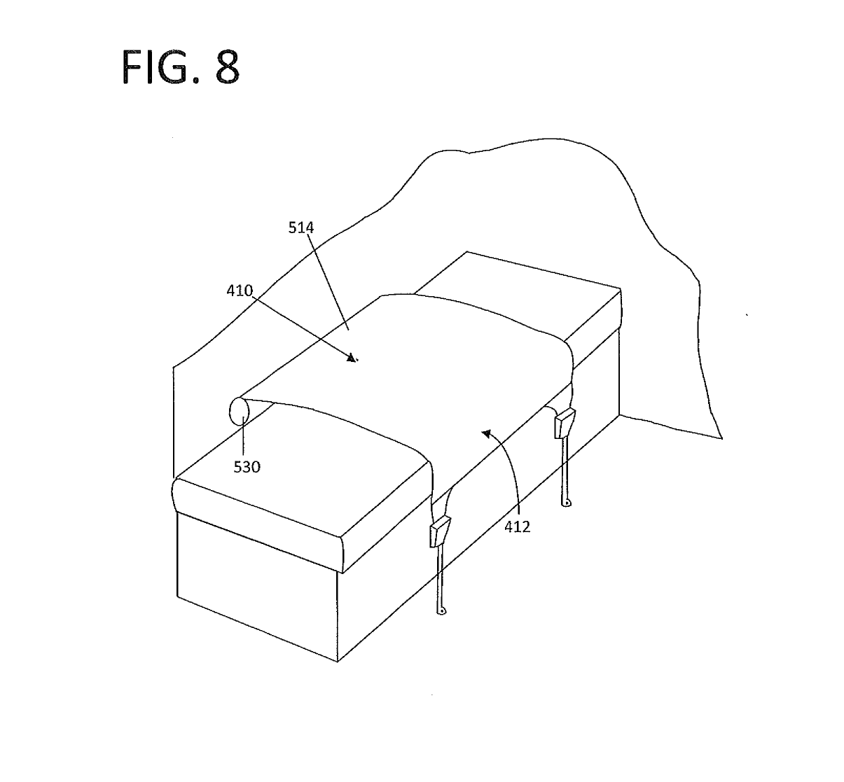

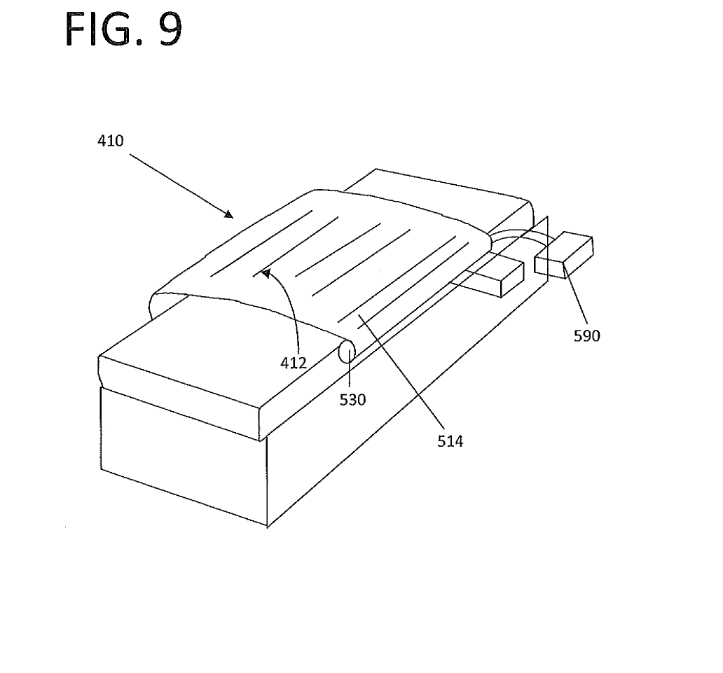

Turning now to FIGS. 8 and 9, a roll over restraint system 510 according to another alternative embodiment is depicted. The roll over restraint system 510 is similar to roll over restraint system 110, except only a single pre-tensioning device 530 is provided. As shown, the pre-tensioning device 530 is associated with the second end 514 of the restraint belt section 512. As shown, the restraint belt section may, if desired, be associated with an inflation device 590 that inflates the restraint belt section 512 as described in relation to the embodiments shown in FIGS. 4 and 5. The present description depicts specific examples to teach those skilled in the art how to make and use the best mode of the invention. For the purpose of teaching inventive principles, some conventional aspects have been simplified or omitted. The detailed descriptions of the above embodiments are not exhaustive descriptions of all embodiments contemplated by the inventors to be within the scope of the invention. Those skilled in the art will appreciate variations from these examples that fall within the scope of the invention.

By way of example, and not limitation, although the one or more activation sensors of the foregoing embodiments are intended to activate the pre-tensioning devices and/or internal bladders in the event of a roll over event, it is within the scope of the present invention for the activation sensors to activate the pre-tensioning devices and/or internal bladders upon the occurrence of at least one of the following: a vehicle deceleration threshold, an vehicle attitude change threshold, or a vehicle crash. Accordingly, within the scope of the present invention, for this purpose, the one or more activation sensors may include a variety of sensors, located at various spots on the vehicle, as is known in the art.

Persons skilled in the art will recognize that certain elements of the above-described embodiments may variously be combined or eliminated to create further embodiments, and such further embodiments fall within the scope and teachings of the invention. It will also be apparent to those of ordinary skill in the art that the above-described embodiments may be combined in whole or in part to create additional embodiments within the scope and teachings of the invention. Thus, although specific embodiments of, and examples for, the invention are described herein for illustrative purposes, various equivalent modifications are possible within the scope of the invention, as those skilled in the relevant art will recognize. Accordingly, the scope of the invention is determined from the appended claims and equivalents thereof.

I claim:

1. A roll over bunk restraint system for a vehicle, comprising:
a mattress;
a restraint belt section provided with a first end and a second end, wherein the restraint belt section extends laterally across the mattress;
at least one pre-tensioning device associated with the second end of the restraint belt section; and
one or more activation sensors that detect the occurrence of at least one of a vehicle declaration threshold, a vehicle attitude change threshold, or a vehicle crash and in response thereto generate a signal that results in the at least one pre-tensioning device increasing the tension applied to the restraint belt section.

2. The roll over restraint system according to claim 1, wherein the mattress is fabricated from visco-elatic polyurethane foam.

3. The roll over restraint system according to claim 1, wherein the first end includes tongues and further comprising buckles that releasably receive the tongues.

4. The roll over restraint system according to claim 1, wherein the second end is associated with at least one retractors.

5. The roll over restraint system according to claim 1, further comprising a blanket that includes sleeves that receive the restraint belt section.

6. A method for providing a roll over bunk restraint system in a vehicle, comprising the steps of:
providing a mattress;
providing a restraint belt section that includes a first end and a second end, wherein the restraint belt section is configured to extend laterally across the mattress;
providing at least one pre-tensioning device that is associated with the second end of the restraint belt section; and
providing one or more sensors that are configured to detect the occurrence of at least one of a vehicle declaration threshold, a vehicle attitude change threshold, or a vehicle crash and in response thereto generate a signal that results in in the at least one pre-tensioning device increasing the tension applied to the restraint belt section.

7. The method according to claim 6, wherein the step of providing the mattress includes the step of providing a mattress fabricated from visco-elastic polyurethane foam.

8. The method according to claim 6, wherein the step of providing the restraint belt section includes the step of providing the restraint belt section with the first end that include tongues and further comprising the step of providing buckles that are configured to releasably receive the tongues.

9. The method according to claim 6, wherein the step of providing the restraint belt section includes the step of providing the restraint belt section with the second end that is associated with retractors.

10. The method according to claim 6, further comprising the step of providing a blanket that includes sleeves configured to receive the restraint belt section.

11. A method for providing a roll over bunk restraint system in a vehicle, comprising the steps of:
providing a mattress;
providing a restraint belt section that includes a first end and a second end, wherein the restraint belt section is configured to extend laterally across the mattress and to inflate and increase a restraint force exerted by the restraint belt section on an occupant, whereby the occupant is substantially held in place on the mattress; and
providing one or more activation sensors that are configured to detect the occurrence of at least one of a vehicle declaration threshold, a vehicle attitude change threshold, or a vehicle crash and in response thereto generate a signal that results in the restraint belt section inflating.

12. The method according to claim 11, wherein the step of providing the mattress includes the step of providing a mattress fabricated from visco-elastic polyurethane foam.

13. The method according to claim 11, wherein the step of providing the first and second restraint belts includes the step of providing the first and second restraint belts with the first ends that include tongues and further comprising the step of providing buckles that are configured to releasably receive the tongues.

14. The method according to claim 11, wherein the step of providing the first and second restraint belts includes the step of providing the first and second restraint belts with the second ends that are associated with retractors.

15. The method according to claim 11, further comprising the step of providing a blanket that includes sleeves configured to receive the first and second restraint belts.

16. The method according to claim 11, further comprising the step of providing at least one pre-tensioning device that is associated with the second end of the restraint belt section; and wherein the step of providing the one or more activation sensors includes the step of providing the one or more sensors that, upon the occurrence of at least one of a vehicle declaration threshold, a vehicle attitude change threshold, or a vehicle crash, are configured to generate a signal that results in in the at least one pre-tensioning device increasing the tension applied to the restraint belt section.
